(19) United States
(12) Patent Application Publication
(10) Pub. No.: US 2005/0265387 A1
(43) Pub. Date: Dec. 1, 2005

(54) General code design for the relay channel and factor graph decoding

(76) Inventors: Mohammad Ali Khojastepour, Plainsboro, NJ (US); Nasir Ahmed, Houston, TX (US); Behnaam Aazhang, Houston, TX (US)

Correspondence Address: Hollingsworth & Funk, LLC;Suite 125, 8009 34th Avenue South, Minneapolis, MN, 55425, US

(21) Appl. No.: 11/094,778

(22) Filed: Mar. 30, 2005

Related U.S. Application Data
(60) Provisional application No. 60/575,877, filed on Jun. 1, 2004.

(51) Int. Cl. H04J 3/16

(52) U.S. Cl. 370/467

(57) ABSTRACT

A system and method of relay code design and factor graph decoding using a forward and a backward decoding scheme. The backward decoding scheme exploits the idea of the analytical decode-and-forward coding protocol and hence has good performance when the relay node is located relatively close to the source node. The forward decoding scheme exploits the idea of the analytical estimate-and-forward protocol and hence has good performance when the relay node is located relatively far from the source node. The optimal decoding factor graph is first broken into partial factor graphs and then solved iteratively using either the forward or backward decoding schemes.

This application claims the benefit of U.S. Provisional Application No. 60/575,877 filed 1 Jun. 2004, the content of which is incorporated herein by reference in its entirety.

### FIELD OF THE INVENTION

This invention relates in general to communication systems, and more particularly to a code design for a relay channel and its associated factor graph decoding.

### BACKGROUND OF THE INVENTION

The past decade has been exciting in terms of the advances introduced in channel coding technology. Coding theory advancement is motivated by the lure of reliable communications over noisy channels at increasingly higher code rates. A central challenge with coding theory has always been to devise a coding scheme that comes close to achieving the channel capacity, while providing a practical level of decoding complexity.

Advancements in coding theory have led to the development of code families such as turbo codes, Low-Density Parity Check (LDPC) codes, and others, that with simple iterative decoding algorithms, achieve performance very close to the Shannon limit on many important channels. The practical application of these codes has proliferated into the use of turbo-like codes in a wide variety of telecommunication standards and a variety of communication systems, such as the Cdma2000 High Rate Packet Data (HRPD) system also known as IS-856.

As coding theory progresses, answers to questions like: “How should the sender encode information that is meant for different receivers in a common signal?”; and “What are the rates at which information can be sent to the different-receivers?” continue to be investigated for each transmission channel, but remain largely in the research domain of the generalized communication network. Such transmission channels of the generalized communication network include: the interference channel (i.e., two senders and two receivers with cross-talk); the two-way channel (i.e., two sender-receiver pairs sending information to each other); and the relay channel (i.e., one source node and one destination node, but with one or more intermediate sender-receiver pairs that act as relay nodes to facilitate the communication between the source node and the destination node.)

It has been shown that the transmission rate of a communication network utilizing the relay channel may be greatly enhanced even beyond the transmission rate currently achievable through the use of Multiple Input Multiple Output (MIMO) systems. MIMO systems make use of multiple antennas at wireless transmitters and receivers to enable increased transmission rates over their respective wireless channels using space-time techniques. Another motivation for using a relay channel comes from the realization that in the case of a cellular network, for example, direct transmission between the base station and mobile terminals that are close to the cell boundary can be very expensive in terms of the transmission power required to insure reliable communications. Thus, relay stations appropriately placed may alleviate some of the transmit power requirements that are imposed by a single transmission link between the base station and the mobile terminal.

In relay channel code design, one needs to specify a code design for the encoder at the source node, and a code design for the encoder at the relay node. Furthermore, the relay node initially does not have access to the message which is about to be transmitted through the relay channel, and so the relay node gathers the information gradually by observing the received symbols at the relay node through the source-relay link. The causality constraint forces the use of only the last received symbols at the relay node for the purpose of coding. Accordingly, the primary difficulty of code design for the relay channel, which makes it completely different from ordinary single link coding, is due to the importance of the design of an effective causal relaying function.

One of the only techniques available today for relay channel code design is based on a turbo code. In this approach, each block of transmission is divided into two halves, where transmission of new information from the source node occurs only-during the first half. The source node then shuts off and transmission from the relay node occurs in the second half. While this technique improves upon multi-hopping, it nevertheless suffers from a considerable rate loss, since no new information is transmitted during the time that relaying is performed.

Furthermore, while recent information theoretical results have shown a considerable improvement in the performance of communication systems through the use of relaying and cooperation, there has been almost no development in the area of real code design for the relay channel.

Accordingly, there is a need in the communication industry for continued progress in coding alternatives for the relay channel, which allows concurrent transmission from the source node and the relay node. Such an alternative would serve to reduce the average power consumption without sacrificing the rate of transmission. The present invention fulfills these and other needs, and offers other advantages over prior art relay channel coding and decoding approaches.

### SUMMARY OF THE INVENTION

To overcome limitations in the prior art described above, and to overcome other limitations that will become apparent upon reading and understanding the present specification, the present invention discloses a system and method for a modular code design approach for the relay channel and corresponding decoding algorithms based on the factor graph representation of the code. The present invention allows concurrent transmission of information from the source node and the relay node, where each transmission is then decoded jointly at the destination node.

In accordance with one embodiment of the invention, a relay channel comprises a source node that is adapted to transmit a plurality of codewords, a relay node that is coupled to receive the plurality of codewords and is adapted to transmit an estimate for each codeword received. The relay channel further comprises a destination node that is coupled to simultaneously receive a superposition of the plurality of codewords and estimates of the plurality of codewords and is adapted to decode each transmitted codeword using partial factor graph decoding. The codeword estimate improves the accuracy of the decoded codeword.

In accordance with another embodiment of the invention, a method of forward decoding information blocks of a relay channel comprises receiving a first information block at a relay node and a destination node, estimating the first information block at the relay node, receiving a superposition of a second information block and the first information block estimate at the destination node, and jointly decoding the first and second information blocks at the destination node. The first information block estimate improves a decoding accuracy of the second information block.

In accordance with another embodiment of the invention, a method of reverse decoding information blocks of a relay channel comprises receiving a predetermined number of information blocks at a relay node and a destination node, estimating the last information block received at the relay node, receiving a superposition of a next to last information block and the last information block estimate at the destination node, and jointly decoding the last and the next to last information blocks at the destination node. The last information block estimate improves a decoding accuracy of the next to last information block.

These and various other advantages and features of novelty which characterize the invention are pointed out with particularity in the claims annexed hereto and form a part hereof. However, for a better understanding of the invention, its advantages, and the objects obtained by its use, reference should be made to the drawings which form a further part hereof, and to accompanying descriptive matter, in which there are illustrated and described representative examples of systems and methods in accordance with the invention.

### BRIEF DESCRIPTION OF THE DRAWINGS

The invention is described in connection with the embodiments illustrated in the following diagrams.

FIG. 1A illustrates a general Gaussian relay channel in accordance with the present invention;

FIG. 1B illustrates a physical model for the relay channel in accordance with the present invention;

FIG. 2 illustrates an exemplary factor graph representation of a regular Low-Density Parity Check (LDPC) code and its shorthand notation;

FIG. 3 illustrates an exemplary factor graph representation where no coding is involved, and a corresponding shorthand notation that represents such a parallel connection;

FIG. 4 illustrates an exemplary factor graph representation of an optimal decoding algorithm in accordance with the present invention;

FIG. 5 illustrates an exemplary factor graph representation of a de-noising algorithm at the relay node in accordance with the present invention;

FIG. 6 illustrates an exemplary partial factor graph representation of backward and forward decoding schemes in accordance with the present invention;

FIG. 7 illustrates an exemplary sum-product decoding algorithm for use by the backward and forward decoding schemes of FIG. 6;

FIG. 8 illustrates an exemplary method of partial factor graph decoding in accordance with the present invention; and

FIG. 9 illustrates exemplary results obtained by the partial factor graph decoding techniques in accordance with the present invention.

### DETAILED DESCRIPTION OF EMBODIMENTS OF THE INVENTION

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

In the following description of various exemplary embodiments, reference is made to the accompanying drawings which form a part hereof, and in which is shown by way of illustration various embodiments in which the invention may be practiced. It is to be understood that other embodiments may be utilized, as structural and operational changes may be made without departing from the scope of the present invention.

Generally, the present invention provides a code design technique for the relay channel and its associated factor graph decoding. The code design is based on two main theoretical results for the relay channel: 1) the decode-and-forward protocol; and 2) the estimate-and-forward protocol, the latter being a newly designed protocol in accordance with the present invention. Besides the general coding technique and general joint factor graph decoding, a specific code design based on the idea of LDPC codes is presented to illustrate advantages associated with the present invention.

In addition, the present invention provides a simplified version of factor graph decoding for the relay channel, which exhibits sufficient simplicity to make real time implementation possible. One general idea in accordance with the present invention is to break the factor graph into partial factor graphs and sequentially solve the partial factor graphs to successively remove the interference. In particular, a modular code design for the relay channel and decoding algorithms is contemplated by the present invention and is based on a factor graph representation of the code. The code construction is performed in three steps: 1) protocol design; 2) constituent code design; and 3) allocation of optimal transmission power. The modular structure allows the code to be adapted to the channel condition and the properties of the transmission media.

An optimal decoding scheme for the code is presented along with two additional sub-optimal decoding schemes, a forward and a backward decoding scheme, where each decoding scheme exhibits much lower complexity. The backward decoding scheme exploits the idea of the analytical decode-and-forward coding protocol and hence has good performance when the relay node is located relatively close to the source node, e.g., about half way or less between the source and destination nodes. The forward decoding scheme exploits the idea of the analytical estimate-and-forward protocol and hence has good performance when the relay node is located relatively far from the source node, e.g., about half way or more between the source and destination nodes.

For most of the relay channel conditions, the constructed code using a low-complexity simple relay protocol in accordance with the present invention outperforms currently known code designs for the direct channel by achieving an Energy per Bit to Receiver Noise Variance ratio (E_{b}/N₀) that is below the minimum required E_{b}/N₀ of single-link transmission. Moreover, the designed codes according to the present invention achieve a gap of less than 1 decibel (dB) from the Shannon limit (at a Bit Error Rate of 10⁻⁶) for the relay channel with a code length of only 2×10⁴ bits.

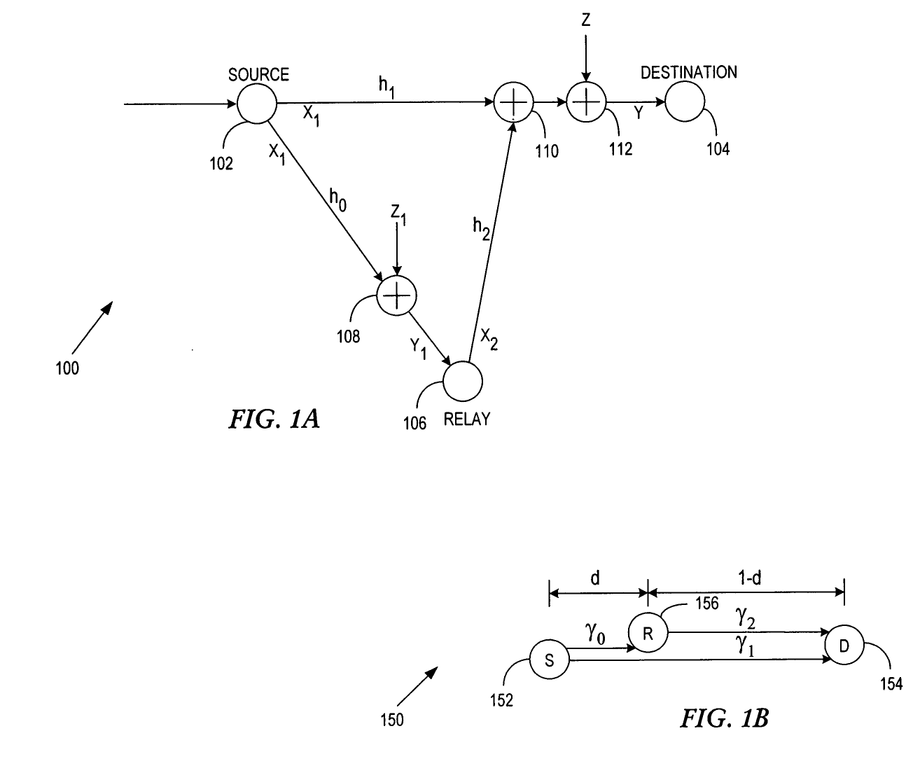

FIG. 1A illustrates Gaussian relay channel 100, in which source node 102 intends to transmit information to destination node 104 by using the direct link between the node pair (source 102/destination 104) and the help of relay node 106, if an improvement in the achievable rate of transmission can be achieved. If relay node 106 can be effective to improve the desired rate of transmission, then link pairs (source 102/relay 106) and (relay 106/destination 104) are utilized to form such a relay channel.

Relay channel 100 consists of an input, x₁, a relay output, y₁, a relay sender, x₂, (which depends only upon the past values of y₁), and a channel output y. The channel is assumed to be memoryless, where the dependency on the outputs is as follows: the channel output is y=h₁×₁+h₂x₂+z, and the relay output is given by y₁=h₀x₁+z₁. Variables h₀, h₁, and h₂ are inter-channel gains and are assumed to be constant, while z and z₁ are independent Gaussian noise terms having zero mean values and variance N and N₁, respectively, where z≈n(0, N) and z₁≈n(0, N₁). The input power constraints are given by E[x₁²]≦P₁ and E[x₂²]≦P₂, where one problem associated with relay channel 100 is to find the capacity of the channel between source node 102 and destination node 104 so as to achieve the best performance for the code.

An (M,n) code for the Gaussian memoryless relay channel of FIG. 1A consists of: a set of integers M={1,2, . . . , M} [symbol] [1,M]; a set of encoding functions x₁ⁿ: M→Rⁿ, where x₁ⁿ denotes an n-tuple (x₁₁, x₁₂, . . . , x₁ₙ); a set of relay functions {fᵢ}i=1ⁿ such that x₂ᵢ=fᵢ(Y₁₁, Y₁₂, . . . , Y₁₍ᵢ₋₁₎) for 1≦i≦n where Y₁ᵢ is the received signal at the relay node and x₂ᵢ is the transmitted signal from the relay node at time i; and a decoding function g: Yⁿ→M. For generality, the encoding functions x₁(^{•}), fᵢ(^{•}) and decoding function g(^{•}) are allowed to be stochastic functions. At source node 102, encoding is based only on the input message x₁. Relay node 106, however, has no access to the input message and because of the non-anticipatory relay condition, relay signal x₂ᵢ is allowed to depend only on the past y₁⁽ⁱ⁻¹⁾=(y₁₁, y₁₂, . . . , y₁₍ᵢ₋₁₎) values of the received signals.

As discussed above, relay channel code design requires the specification of a code design for the encoder at source node 102, and a code design for the encoder at relay node 106. As will be discussed in more detail below, the specific choice of the relay function is referred to as a protocol, and the codes that are used at the source and relay nodes are referred to as the constituent codes. Thus, construction of the code for relay channel 100 in accordance with the present invention contains three major elements: protocol selection; constituent code selection; and power assignment.

In practice, the relay node position provides a better model for relay channel code evaluation as compared to the abstract relay channel parameters. Relay channel model 150 of FIG. 1B is thus illustrated, which normalizes all distances based upon the distance between source node 152 and destination node 154. That is to say that all distances are normalized to the source-destination distance of unity and for simplicity, relay node 156 is positioned along a straight line between source node 152 and destination node 154 at a distance, d, from source node 152, which further establishes the relay-destination distance to be equal to 1−d.

The channel gains may be expressed as

$${γ}_{0} {=}^{Δ} \frac{{\vert {h}_{0} \vert}^{2}}{{N}_{1}} , {γ}_{1} {=}^{Δ} \frac{{\vert {h}_{1} \vert}^{2}}{N} , and {γ}_{2} {=}^{Δ} \frac{{\vert {h}_{2} \vert}^{2}}{N} ,$$

respectively. Normalization of the channel gain values, however, may also be normalized to the source-destination channel gain and subsequently related to the normalized distance parameter, d, as follows:

$${γ}_{0} = \frac{1}{{d}^{α}} , {γ}_{1} = 1 , and {γ}_{2} = \frac{1}{{( 1 - d )}^{α}} ,$$

where α is the pathloss exponent and typically lies in the range between 2 and 5 and the set of channel gains (γ₀, γ₁, γ₂) is assumed to be fixed over time.

The protocol element of relay channel code design in accordance with the present invention includes the transmission of information from source node 102 in B equal length blocks b=1, 2, . . . , B. Every two consecutive blocks use two different block codes of length N each, which are called constituent codes. In a simple design, one may choose only two constituent codes that are used alternately in the blocks with an odd or even index.

At each block, b, the source node sends a new codeword w_{b}. At the end of block, b, the relay node estimates the transmitted codeword, w_{b}, from the source by using the relay's received signal in this block. The relay's estimate, w_{b}′, is the closest codeword to the received signal, which is then sent in block b+1 without the need to re-encode. It should be noted that if the source-relay link is good, w_{b}′ is most likely decoded correctly, thus resembling the decode-and-forward coding scheme. On the other hand, when the source-relay link is not good, w_{b}′ can be interpreted as the best estimate of the relay received signal, which resembles the estimate-and-forward coding scheme.

The optimal decoding algorithm according to the present invention is to wait for the entire transmission of B blocks and then jointly decode all of the codewords that are transmitted by source node 102, with the help of relay node 106. In an alternate embodiment according to the present invention, two sub-optimal algorithms are presented, i.e., the forward and the backward decoding schemes, which exhibit very good performance with several orders of magnitude reduction in complexity as compared to the optimal decoding algorithm.

The set of constituent codes used in the source and relay nodes consists of all equal length codes, e.g., length=N, having the following parameters: 1) there are at least two constituent codes in the set; 2) each constituent code is chosen such that they have good performance in a single link channel; and 3) every pair of constituent codes has good performance in a multiple access channel where they are jointly decoded. The optimal design of the constituent codes depends on both the chosen protocol and their given power allocation. The family of irregular LDPC codes, for example, exhibit very good performance, while allowing for code optimization and thus are excellent candidates for the implementation of the constituent codes. More importantly, the LDPC codes may be optimized jointly using two possible approximations of the density evolution method, i.e., the Gaussian approximation and the Erasure channel approximation.

It is, however, difficult to find the optimized LDPC code profile for the factor graph of the whole B blocks of transmission. Alternatively, good code designs are considered for the partial factor graph and will be discussed in more detail below. The resulting two sets of codes may then be used alternately over B transmitted blocks. Moreover, since the joint decoding of all B transmitted codewords is tedious, successive decoding algorithms are discussed below, which are optimized for use with the resulting two sets of codes.

The power assignments for relay channel 100 depend upon the channel parameters in addition to the relay protocol being used. Should the source and the relay channel share the available power (e.g., using a sum power constraint, P=P₁+P₂, where P₁ is the power transmitted by the source node and P₂ is the power transmitted by the relay node), an optimal ratio of the power allocation is found which achieves the best performance for the code. The power allocation ratio along with the possible power allocations across the B blocks of the transmission may be considered as parameters that may be used to further improve the transmission rate achievable through use of the code design.

An upper bound for the information transfer rate, R, in the discrete memoryless relay channel of FIG. 1A may be expressed in terms of the channel parameters and the power constraints as follows:

$$R \leq \frac{1}{2} {max}_{ρ , 0 \leq ρ \leq 1} min \{ log ( 1 + ( 1 - {ρ}^{2} ) ( {γ}_{0} + {γ}_{1} ) {P}_{1} ) , log ( 1 + {γ}_{1} {P}_{1} + {γ}_{2} {P}_{2} + 2 ρ \sqrt{{γ}_{1} {γ}_{2} {P}_{1} {P}_{2}} ) \} \qquad ( 1 )$$

where

$${γ}_{0} {=}^{Δ} \frac{{\vert {h}_{0} \vert}^{2}}{{N}_{1}} , {γ}_{1} {=}^{Δ} \frac{{\vert {h}_{1} \vert}^{2}}{N} , and {γ}_{2} {=}^{Δ} \frac{{\vert {h}_{2} \vert}^{2}}{N} .$$

The role of parameter, ρ, corresponds to the correlation factor between the channel input, X₁, and the relay signal X₂. For different channel parameters h₀, h₁, h₂, N₁, and N, there are different values of the correlation factor, ρ, which optimizes R of equation (1). It can be seen, therefore, that by introducing correlation between the channel input and relay signal, an increase in the information transfer rate may be achieved.

As discussed above, one of two schemes may be used by relay node 106 when performing a de-noising operation, such that the de-noising operation either conforms to a decode-and-forward scheme, or an estimate-and-forward scheme. In the decode-and-forward scheme, transmission occurs in several blocks of long codewords. In each block, some information is solely encoded for the reception at the relay, where the codeword length is long enough to allow almost error free decoding by the relay. Thus, the source and relay nodes cooperate in resolving the ambiguity at the destination node about the message sent during the previous block by using the information that is now shared between the source and relay nodes.

The achievable rate of the decode-and-forward scheme for the Gaussian relay channel is given by:

$${R}_{DF} = \frac{1}{2} {max}_{ρ , 0 \leq ρ \leq 1} min \{ log ( 1 + ( 1 - {ρ}^{2} ) {γ}_{0} {P}_{1} ) , log ( 1 + {γ}_{1} {P}_{1} + {γ}_{2} {P}_{2} + 2 ρ \sqrt{{γ}_{1} {γ}_{2} {P}_{1} {P}_{2}} ) \} , \qquad ( 2 )$$

whereas the achievable rate of the direct transmission for the Gaussian relay channel is given by:

$${R}_{Direct} = \frac{1}{2} log ( 1 + {γ}_{1} {P}_{1} ) \qquad ( 3 )$$

Equations (2) and (3) above imply that if the relay node has a greater received Signal-to-Noise Ratio (SNR) with respect to the destination node's received SNR (i.e., γ₀>γ₁), then using the relay is helpful to improve the achievable rate of the direct transmission. If, however, the received SNR at the relay node is not as good as the received SNR at the destination node (i.e., γ₁>γ₀), then there is no gain over direct transmission by using the decode-and-forward scheme even if the available power at the relay node is very large.

In such an instance, an estimate of the received signal at the relay node may be used, where similarly to the decode-and-forward scheme, the estimate-and-forward scheme encodes using several blocks of a large codeword length. The achievable rate of the estimate-and-forward scheme for the Gaussian relay channel is given by:

$${R}_{EF} = \frac{1}{2} log ( 1 + {γ}_{1} {P}_{1} + \frac{{γ}_{0} {P}_{1} {γ}_{2} {P}_{2}}{1 + {γ}_{0} {P}_{1} + {γ}_{1} {P}_{1} + {γ}_{2} {P}_{2}} ) \qquad ( 4 )$$

By comparing equations (4) and (3), it is clear that the achievable rate, R_{EF}, of the estimate-and-forward scheme is always greater than the achievable rate, R_{Direct}, of direct transmission. On the other hand, depending upon channel conditions, the decode-and-forward scheme may achieve a superior transmission rate over the estimate-and-forward scheme.

One of the most important aspects of code design for the relay channel, subject to the sum power constraint, is the optimal power allocation between the relay and source nodes. The power allocation is defined in terms of

$$k {=}^{Δ} \frac{{P}_{2}}{{P}_{1} + {P}_{2}} ,$$

which is the ratio of the relay power to the sum power of the source and relay. The optimal value, k, may be found by maximizing the rate of transmission given by equations (2) and (4) subject to the sum power constraint, P₁+P₂=P.

The primary difficulty of code construction for the relay channel that makes it inherently different from ordinary single-link code design is due to the distributed nature of coding in the source and relay nodes. Thus, one of the challenges is the design of the forwarding strategy at the relay node, while another challenge corresponds to the joint coding between the source and relay nodes. The forwarding strategy expresses how to build the relay transmit signal based on the past relay received signals. Furthermore, two codebooks should be generated, one to be used by the encoder at the source node, and one for the encoder at the relay node.

As discussed above, the codes used in the decode-and-forward and the estimate-and-forward schemes may be described by a parity check matrix, H, and its associated factor graph. A factor graph representation of the code consists of: 1) a vector of “variable nodes”, where each variable node corresponds to a column of the parity check matrix, H, and is denoted by circles; 2) a vector of “check nodes”, where each check node corresponds to a row of the parity check matrix, H, and is denoted by a square; and 3) connections between the check nodes and the variable nodes that correspond to a logic value of“1” in the corresponding row and column of the parity check matrix, H.

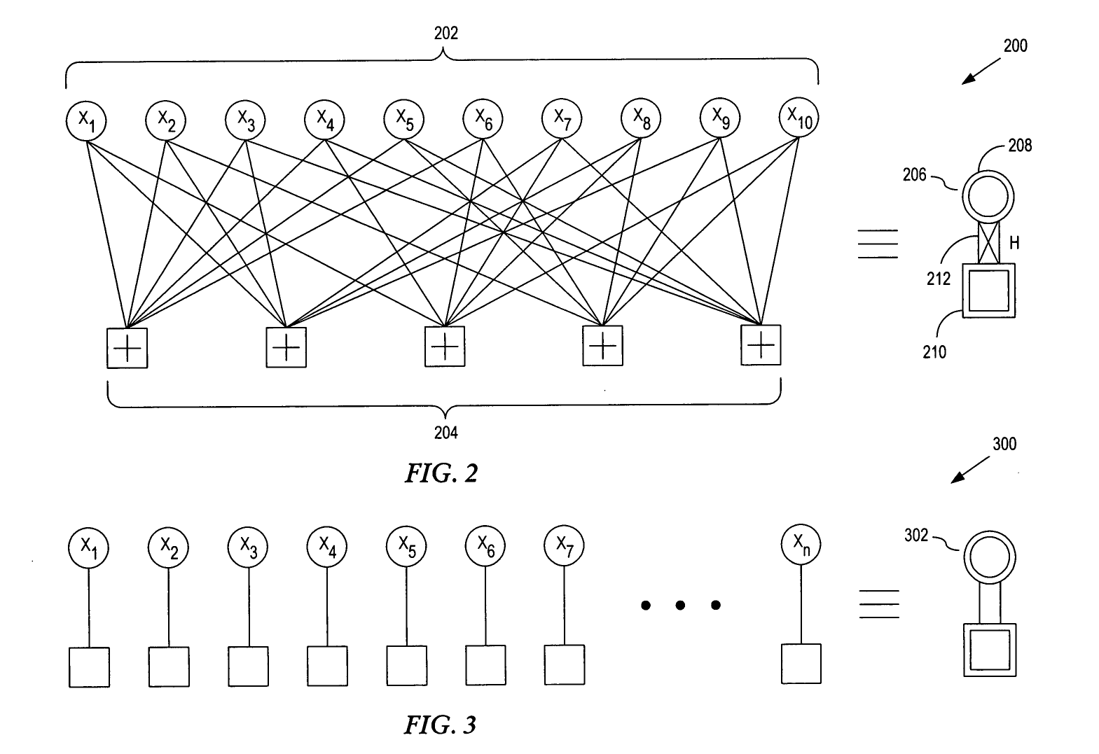

For example, factor graph representation 200 of FIG. 2 exhibiting a regular (3,6) LDPC code with rate ½ may be associated with the following parity check matrix:

$$H = [ \begin{matrix}1 & 1 & 1 & 1 & 1 & 1 & 0 & 0 & 0 & 0 \\ 1 & 1 & 1 & 0 & 0 & 0 & 1 & 1 & 1 & 0 \\ 1 & 0 & 0 & 1 & 0 & 1 & 1 & 1 & 0 & 1 \\ 0 & 1 & 0 & 0 & 1 & 1 & 0 & 1 & 1 & 1 \\ 0 & 0 & 1 & 1 & 1 & 0 & 1 & 0 & 1 & 1\end{matrix} ] \qquad ( 5 )$$

Variable nodes 202 correspond to symbols, x₁, x₂, . . . , x₁₀, where 6 of the 10 symbols are to be used in each LDPC codeword. There are also 5 check nodes 204 that represent the binary linear equations that each codeword must satisfy. It can be seen by inspection that each check node 204 has degree 6, while each variable node 202 has degree 3.

In a valid codeword, the neighbors of every check node 204 (i.e., the variables connected to the check node by a single edge) must form a configuration with a binary sum of zero (i.e., a configuration with an even number of logic ones.) In other words, for the (3,6) LDPC code, each check node 204 corresponds to a binary sum of variable nodes 202 as follows:
x₁⊕x₂⊕x₃⊕x₄⊕x₅⊕x₆=0 (6)
x₁⊕x₂⊕x₃⊕x₇⊕x₈⊕x₉=0 (7)
x₁⊕x₄⊕x₆⊕x₇⊕x₈⊕x₁₀=0 (8)
x₂⊕x₅⊕x₆⊕x₈⊕x₉⊕x₁₀=0 (9)
x₃⊕x₄⊕x₅⊕x₇⊕x₉⊕x₁₀=0 (10)
where equations (6) through (10) correspond to the binary linear equations that each valid codeword must satisfy. Given a particular instance of codeword C, for example, one can verify whether C is valid by taking the modulo-2 sum (i.e., ⊕) of the binary variables that comprise codeword, C, as directed by equations (6) through (10). If each equation results in a binary sum of zero, then the codeword is considered to be valid. Symbol 206 represents the short-hand (i.e., symbolic) representation of a factor graph having vector variable node 208, vector check node 210, and parity check matrix 212, which represents the connection between vector check node 210 and vector variable node 208.

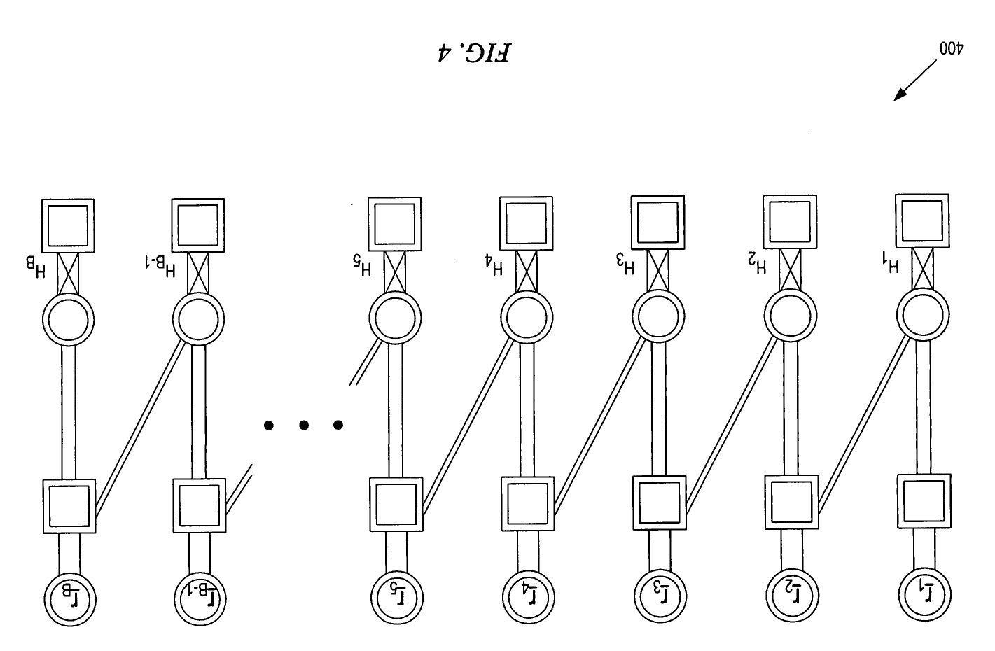

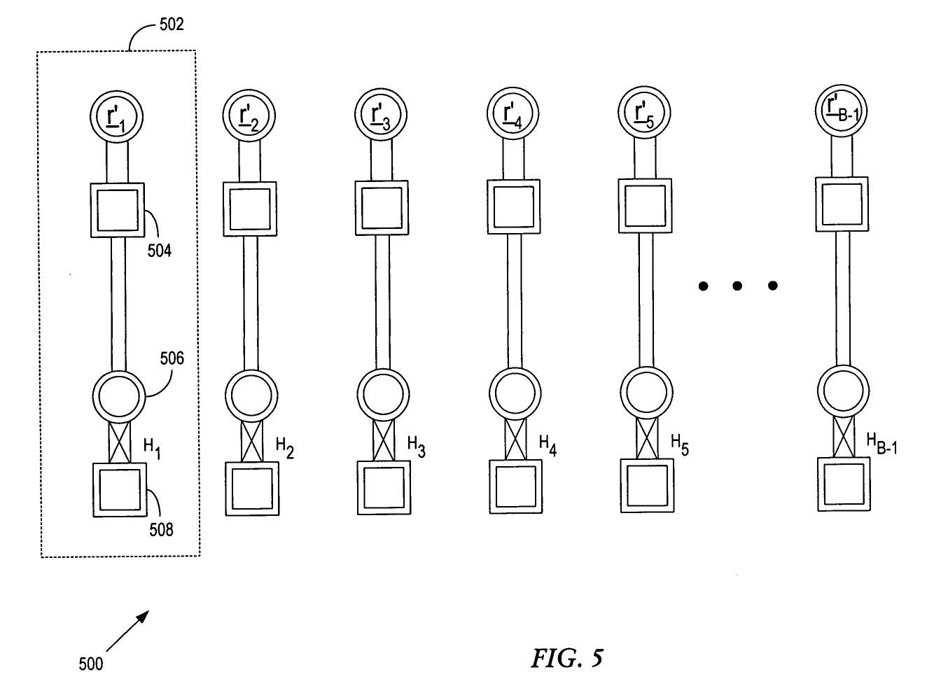

FIG. 3 exemplifies factor graph 300, whereby no coding is involved, i.e., H=I, where I is the identity matrix. In such an instance, each vector check node is simply equal to its respective vector variable node as illustrated by the series of parallel connections between the variable and check nodes. Symbol 302 illustrates the short-hand notation for this trivial case.

Through the use of the short-hand notations 206 and 302 of FIGS. 2 and 3, factor graph 400 of the proposed code for relay coding in accordance with the present invention may be illustrated. Vectors r₁, r₂, . . . , and r_{B} denote the received vectors in the 1^{st}, 2^{nd}, . . . , B^{th} transmission blocks at the destination node. The parity check matrices of the constituent codes for the consecutive codewords in the B blocks are denoted by H₁, H₂, . . . , H_{B}, respectively. Each codeword that is transmitted from the source in block b=1, 2, . . . , B, is either decoded or estimated by the relay node and then retransmitted in the next block b+1. Therefore, the codeword w_{b}, which is encoded by the code having parity check matrix H_{b}, affects both the received vectors r_{b} and r_{b+1} at the destination node. As such, a priori information about the codeword w_{b} is obtained through both r_{b} and r_{b+1} as illustrated in FIG. 4. Thus, the optimal decoder at the destination node is the decoder that solves factor graph 400 to find all of the transmitted codewords jointly.

Additionally, factor graph 500 of FIG. 5 may be used to illustrate the code at the receiver of the relay node, where r′₁, r′₂, r′₃, . . . , and r′_{B} denote the received vectors in the 1^{st}, 2_{nd}, . . . , B^{th} transmission blocks at the relay node. At each block, b, the relay node attempts to find the MAP estimate of the transmitted codeword from the source based on its received vector in the same block. This process is identical to solving factor graph 500, although the goal is not necessarily to decode the transmitted codeword w_{b}. In fact, for some relaying conditions, the transmission rate might be higher than the capacity of the source-relay link. In such an instance, the resulting codeword would be in error with high probability.

In this instance, while the codeword is not decoded correctly, it nevertheless results in a best estimate of the received codeword and is forwarded to the destination node to help the destination node calculate the initial probabilities of the codeword symbols. Thus, the factor graph solver in this instance is a quantizer that quantizes the relay received vector with a rate that can be reliably transmitted over the relay-destination link. The factor graph solver in fact finds the closest codeword to the received signal, which corresponds to the center of the optimal region for the given quantizer. Furthermore, since the output of the process is already a valid codeword, it is directly forwarded in the next block without the need to re-encode the information. It should be noted that the factor graph of the codes in different blocks are isolated, which provides a de-noising operation at the relay node that is much simpler than decoding at the destination node as depicted in FIG. 4.

In a first embodiment, joint decoding of all B blocks is performed by solving factor graph 400 using a MAP algorithm for an optimal decoding strategy. If constituent codes, e.g., H₂ and H₃, are chosen to be LDPC codes, however, then it is possible to use the practically implementable method of belief propagation as the optimal decoding strategy. The same method of belief propagation may also be extended for use where the constituent codes are either convolutional or turbo codes. The factor graph representation of these codes and their corresponding decoding schemes is known and will not be further discussed herein.

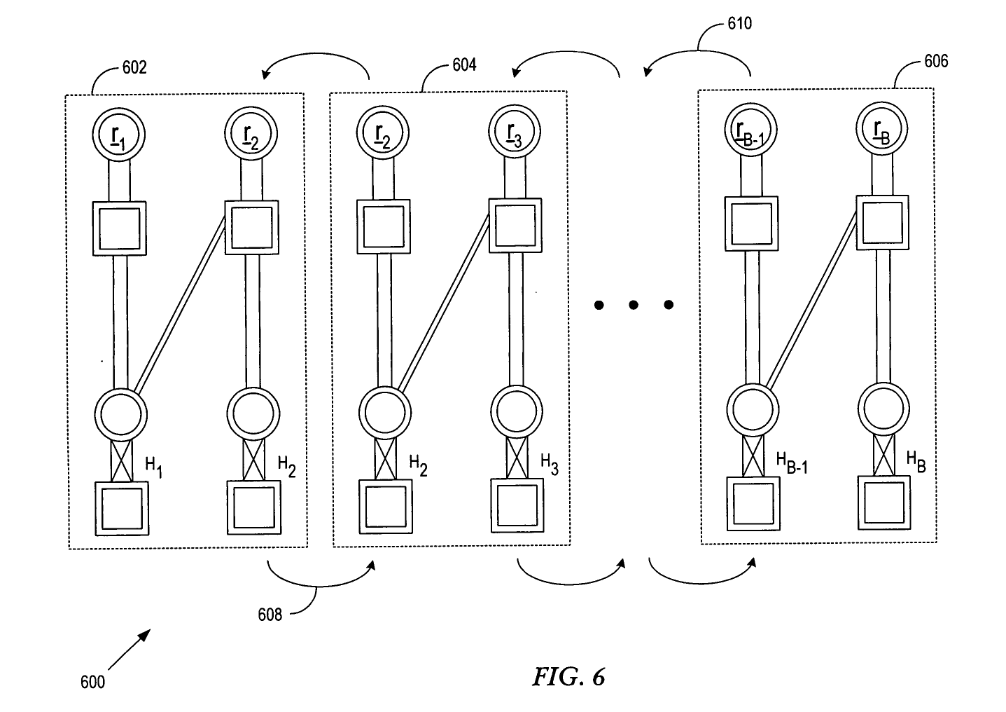

In a second embodiment according to the present invention, the original factor graph of the code as illustrated in FIG. 4 is broken down into a sequence of smaller factor graphs 602-606, called partial factor graphs, as exemplified in FIG. 6. Two successive decoding schemes, the forward decoding scheme and the reverse decoding scheme, may then be applied to the partial factor graphs 602-606, each of which exhibit very good performance with orders of magnitude lower decoding complexity as compared to the joint decoding of all B blocks as illustrated in FIG. 4. It should be noted that if the constituent codes are some other form of block codes, such as turbo codes or convolutional codes, the same forward or backward decoding schemes can still be successfully exploited. The challenge remains, however, to find the optimal joint design of the block codes for the coding structures of FIG. 4 and FIG. 6.

In the forward decoding scheme, as depicted by directional arrows 608 of FIG. 6, decoding begins from the left to decode the first block and successively proceeds forward by removing the interference of the last decoded block from the current block. One inherent benefit of the forward decoding scheme, is that the decoding delay is no more than two blocks because the decoding of block, b, can be done right after reception of block, b+1. As discussed above, however, the performance of the forward decoding scheme is superior to the performance of the reverse decoding scheme, only when the position of the relay is far from the source (i.e., d>1−d of FIG. 1B). In such an instance, the forward decoding scheme in conjunction with the coding strategy of the present invention follows the idea of the information theoretical estimate-and-forward coding scheme for the relay channel. A simple calculation of the a priori bit probabilities of the codewords for the first partial factor graph 602 and the last partial factor graph 606 also confirms that the a priori information is stronger if decoding starts from partial factor graph 602.

In the backward decoding scheme, the factor graph of FIG. 4 is again broken down into partial factor graphs 602-606. However, the decoding starts from the rightmost partial factor graph 606 to decode the last block and successively proceeding backward, as indicated by directional arrows 610, by removing the interference of the last decoded block from the current block. Despite the low decoding latency of the forward decoding scheme, backward decoding is in fact more efficient for positions of the relay node closer to the source node (e.g., d<1−d of FIG. 1B). The reason is that the backward decoding scheme along with the coding strategy of the present invention follows the idea of the information theoretical decode-and-forward coding scheme for the relay channel. A simple calculation of the a priori bit probabilities of the codewords for the first partial factor graph 602 and the last partial factor graph 606 also confirms that the a priori information is stronger if decoding starts from partial factor graph 606.

The backward decoding scheme may be of more interest because the relay node that is positioned closer to the source node is generally more desirable. However, the backward decoding scheme exhibits a larger decoding delay, since decoding cannot start before receiving the entire block B transmission. Thus, the backward decoding scheme exhibits a decoding delay of at least B blocks, as opposed to the forward decoding scheme, which exhibits a decoding delay of only two blocks as discussed above.

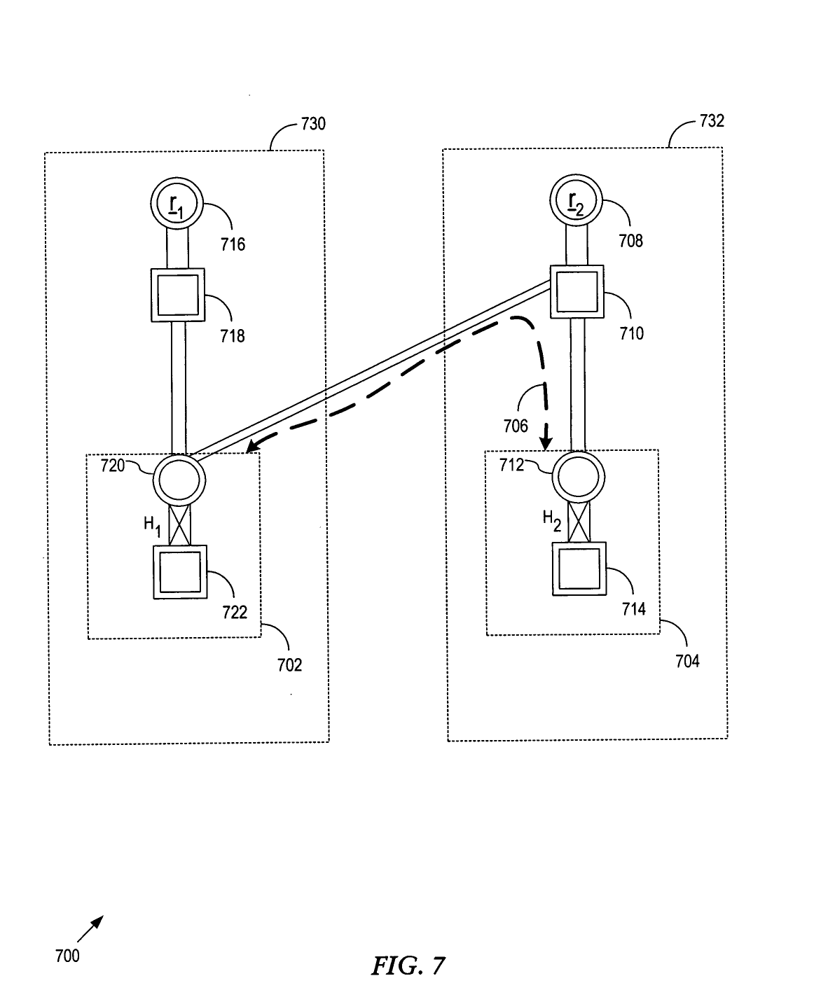

As discussed above, the decoding of the current block is performed by successive interference cancellation from the last decoded codeword followed by a solution to the resulting partial factor graphs. It should be noted that the resulting partial factor graphs from the forward or backward decoding schemes after successive interference cancellation have an identical structure. Therefore, it is enough to discuss the partial factor graph 700 for the first and second blocks of transmission as exemplified in FIG. 7.

Vector variable nodes 716 and 708 represent two sets, or vectors, of variable nodes. Each of vector variable nodes 716 and 708 are connected in parallel to respective vector check nodes 718 and 710, which are in turn connected in parallel to respective vector variable nodes 720 and 712 of parity check matrices H₁ and H₂, respectively. The vector variable nodes 720 and 712 are connected in parallel to respective vector check nodes 722 and 714 of parity check matrices H₁ and H₂.

Vector r₁ represents the received signal at the destination node which pertains to the b=1 transmission block (i.e., w₁) that is transmitted from the source node. It should be noted that the relay node also receives a vector relating to transmitted codeword w₁ and it is denoted as r₁′, as illustrated for example, by factor graph 502 of FIG. 5, where vector r₁′ subsequently undergoes a de-noising process. In particular, once vector r₁′ has been received by the relay node, vector check node 504 computes the Log Likelihood Ratio of the received vector r₁′ (LLR_{r1′}), where LLR_{r1′}=ln(p(r₁′|v=0)/p(r₁′|v=1)). The LLR_{r1′} first computes the conditional probabilities for each bit of received vector r₁′ given bit values of 0 and 1 and then the natural log of the ratio is computed to generate LLR_{r1′}.

LLR_{r1′} is then transmitted by vector check node 504 to vector variable node 506 as a message via the parallel connection between vector check node 504 and vector variable node 506. The message is then converted to bit probabilities by vector variable node 506 and then checked for compliance by vector check node 508 as defined by parity check matrix H₁. Similar messages are then exchanged between vector check node 508 and vector variable node 506, whereby the process is repeated using an iterative sum-product algorithm until a predetermined termination threshold has been reached.

The predetermined termination threshold may be achieved in one of two ways. First, the iteration can proceed to the point at which there is complete compliance with parity check matrix H₁, in which case the valid codeword has been successfully decoded. Second, a maximum number of iterations have been executed, but complete compliance with parity check matrix H₁ has not yet been reached. Thus, bit errors still exist within the received vector as compared to the transmitted codeword, resulting in a best estimate for the received codeword. The number of bit errors resulting in the best estimate is, nevertheless, an improvement upon the number of bit errors contained within the received vector and is, therefore, used. Once either of the two termination thresholds is reached, the received vector r₁′ is considered to be de-noised by the relay node, which results in either a perfect decode of the transmitted codeword, or at least a best estimate of the transmitted codeword.

Vector r₂ represents the received signal at the destination node which pertains to the b=2 transmission block (i.e., w₂) that is transmitted from the source node. By the time w₂ has been transmitted by the source node, however, vector r₁ has been de-noised by the relay node, as discussed above, and is then forwarded onto the destination node by the relay node as codeword w₁′. Thus, vector r₂ represents a superposition of the de-noised codeword that is transmitted by the relay node, w₁′, with the newly transmitted codeword, w₂, from the source node.

In contrast to the solution of factor graph 502 of FIG. 5 as discussed above, a joint solution of factor graphs 730 and 732 of FIG. 7 must be accomplished, since vector variable node 720 of factor graph 730 is a neighbor to vector check node 710 of factor graph 732 as denoted by the parallel connection between the two nodes. Thus, received vector r₂ has a direct impact on the decoding process of received vector r₁ due to messages 706 that are exchanged between vector check node 710 and vector variable node 720.

In fact, vector check node 710 has three separate connections to each of the three neighbors of vector check node 710 and they are: vector variable node 708; vector variable node 720; and vector variable node 712. Messages from each of the neighbors are sent to vector check node 710 during one iteration of the joint solution of factor graphs 730 and 732. In response to the received messages, vector check node 710 then calculates response messages (i.e., LLRs), to be sent to each of its neighbors during a second iteration. The process is then repeated using a sum-product algorithm until terminated in accordance with a predetermined termination rule.

Generally speaking, the sum-product algorithm allows the computation of the a posteriori probability mass function, p(xᵢ|y), where in the case of factor graph 732 of FIG. 7, y represents the received vector, r₂, and xᵢ represents a valid codeword as defined by parity check matrix H₂. Symbol-by-symbol maximum aposteriori (MAP) decoding requires such a computation, so that the most likely value for xᵢ may be selected. However, since there are many valid codewords corresponding to parity check matrix, H₂, the joint a posteriori probability mass function must be calculated, which requires a marginalization operation of the form:

$${g}_{i} ( {x}_{i} ) = {\sum }_{{x}_{1}} … {\sum }_{{x}_{i - 1}} {\sum }_{{x}_{i + 1}} … {\sum }_{{x}_{n}} g ( {x}_{1} , … , {x}_{n} ) \qquad ( 11 )$$

where gᵢ(xᵢ) represents the joint aposteriori probability mass function. The sum-product algorithm, therefore, is a procedure that is used to organize the simultaneous computation of marginals of equation (11), which ultimately either leads to finding the actual codeword, xᵢ, or a best estimate for the codeword, xᵢ′.

The sum-product algorithm may be understood as operating by passing messages over the edges of the factor graph (i.e., the connections between vector variable nodes and vector check nodes.) The messages are actually functions, which may be passed in either direction over the edge. That is to say that a message may be transmitted by a vector variable node to a vector check node, or by a vector check node to a vector variable node. Since each message is a function, they can be multiplied as functions. Thus, if μ₁(x) and μ₂(x) are messages that are functions of x, then their product μ₁(X)*μ₂(X) is also a well-defined function of x. Likewise, if μ₁(x) and μ₂(y) are messages that are functions of x and y, then their product μ₁(x)*μ₂(y) is also a well-defined function of the pair (x,y).

The sum-product rule is defined in terms of two simple update rules: the vector variable node update rule and the vector check node update rule. The update rule for vector variable nodes states that the message sent from the vector variable node to the recipient vector check node is obtained by multiplying the messages received at the vector variable node from its neighbors other than the recipient vector check node. For example, message 706 that is sent to vector check node 710 from vector variable node 720 is the product of messages received at vector variable node 720 from vector check nodes 718 and 722.

Similarly, the update rule for vector check nodes states that the message sent from the vector check node to the recipient vector variable node is obtained by multiplying the messages received at the vector check node from its neighbors other than the recipient vector node and then marginalizing the resulting function. For example, message 706 that is sent to vector variable node 720 from vector check node 710 is the marginalized product of messages received at vector check node 710 from vector variable nodes 708 and 712.

Generally, any message passed over an edge that is incident on a variable, x, is a function over the alphabet on which the variable is defined (i.e., a function of x). If, for example, x is a binary variable defined on the alphabet {0,1}, then messages passed on any edges incident on x will be a function of the form μ(x). Such functions may be specified by the vector [μ(0), p(1)], or if scale is not important, by the ratios μ(0)/μ(1) or log(μ(0)/μ(1)).

The goal of the sum-product algorithm as implemented in FIG. 7, is to decode both transmitted codewords, w₁ and w₂, after reception of the corresponding vectors, r₁ and r₂. Once the first and second blocks of transmission are received at the destination node, bit probabilities for both w₁ and w₂ codewords are calculated based on received vectors, r₁ and r₂. Then, the joint decoding of both transmitted codewords w₁ and w₂ at the first and second blocks is performed iteratively by passing messages 706 between the two parts, 702 and 704, through vector check node 710.

It should be noted, that received vector r₁ is a result of the transmitted codeword, w₁, from the source node. Received vector r₂, on the other hand, contains both the transmitted codeword, w₂, from the source node, but also contains the re-transmitted, de-noised codeword, w₁′, as transmitted by the relay node. Thus, the joint decoding algorithm as illustrated in FIG. 7 utilizes two versions of received codeword, namely w, as received in block 730 from the source node and the superposition of w₂ and w₁′ as received in block 732 from the relay node. Thus, decoding of codeword w₁ is generally more precise than the decoding of codeword w₂, since the “helper” codeword, w₁′, exists to enhance the decoding of codeword w₁ at block 730.

As the algorithm advances to jointly decode the next pair of received vectors (i.e., r₂ and r₃) as exemplified by partial factor graph 604 of FIG. 6, decoding of codeword w₂ is generally more precise than the decoding of codeword w₃ since in this case, the “helper” codeword, w₂′, exists to enhance the decoding of codeword w₂. It should be noted that advancement of the decoding scheme may occur from left to right, as is the case with the forward decoding scheme denoted by direction 608 of FIG. 6, or conversely, advancement of the decoding scheme may occur from right to left, as is the case with the reverse decoding scheme denoted by direction 610 of FIG. 6.

In particular, during the factor graph solution of block 732, block 704 iterates towards a solution for codeword w₂ based upon factor graph decoding of received vector r₂ using the sum-product method as discussed above. In addition, block 704 has received the de-noised codeword, w₁′, from the relay node. The LLR for de-noised codeword, w₁′, is then forwarded to vector variable node 720 of block 702 from vector check node 710. Thus, vector variable node 720 is in receipt of both the LLR for received codeword, w₁, from vector check node 718, as well as the LLR for received codeword, w₁′, from vector check node 710. As such, the received codeword, w₁, and the de-noised version of codeword w₁ (i.e., w₁′) are used by vector variable node 720 to improve the decoding solution for codeword w₁.

In order to more fully illustrate the joint decoding solution illustrated by FIG. 7, the following code sequence is presented, which is to be understood as a joint decoding solution where y is equal to the received vector, r₂. A declaration of variables, along with their respective meanings, is first provided in code segment (12) as follows:

%---------------------------------------------------------------------

| | | |
|---|---|---|
| % | Declaration of variables | (12) |

%---------------------------------------------------------------------
num_v : is the number of variable nodes in each constituent code
y(1,num_v) : is the received signal (e.g., y = r₂)
x(1,num_v) : is the received signal if there was no noise.

| | |
|---|---|
| v_dec(1,num_v) : | is the decoded codeword |
| mv_y(1,num_v) : | is the Log Likelihood Ratio (LLR) of the received signal, |
| | defined as ln(p(y\|v=0)/p(y\|v=1)) |
| mc(num_edge,1) : | is the message to check nodes for a given edge |
| mv(num_edge,1) : | is the message to variable nodes for a given edge, where |
| | the messages are LLRs given by |
| | LLR = ln(p(e\|v=0)/p(e\|v=1)) |
| sum_mv(1,num_v) : | sum of all incoming messages to variable nodes |
| sum_mc(num_c,1) : | sum of all incoming messages to check nodes |
| idx_v(num_edge,1) : | index the variable node to which the edge is connected |
| idx_c(num_edge,1) : | index the check node to which the edge is connected |

%---------------------------------------------------------------------

| | |
|---|---|
| % | Initialization of the variables |

%---------------------------------------------------------------------

| | |
|---|---|
| mv=zeros(1,length(idx_c)); | // initialize mv for the code 1 and mv_2 for |
| mv_2=zeros(1,length(idx_c2)); | // the code 2 |

// priorSij means prior probability that each bit of wᵢ is equal to j

| | |
|---|---|
| priorS10 = 0.5; priorS11 = 0.5; | // set all prior probabilities of the bits for |
| | // each codeword to ½, since |
| priorS20 = 0.5; priorS21 = 0.5; | // no prior probability is known |

// prob_x_ij means that the probability that x = a1*i + a2*j given that the
// received signal r2 is equal to y.
// prob_x_00 is the probability that source node has sent a 0 and the relay
// node has also sent a 0
prob_x_00 = const*exp(−((y−(a1+a2))\hat{ }2)/(2*var_noise));
// prob_x_10 is the probability that source node has sent a 1 and the relay
// node has sent a 0
prob_x_10 = const*exp(−((y−(−a1+a2))\hat{ }2)/(2*var_noise));
// prob_x_01 is the probability that source node has sent a 0 and the relay
// node has sent a 1
prob_x_01 = const*exp(−((y−(a1−a2))\hat{ }2)/(2*var_noise));
// prob_x_11 is the probability that source node has sent a 1 and the relay
// node has also sent a 1
prob_x_11 = const*exp(−((y−(−a1−a2))\hat{ }2)/(2*var_noise));
// gammainSij is the probability that each bit of wᵢ is equal to j

| | |
|---|---|
| gammainS10 = 0.5; | // this value is initially ½ but the next time it |
| | // will be calculated from the messages which come |
| gammainS11 = 0.5; | // from the vector variable node 712 relating to the |
| | // second codeword w₂ |

%---------------------------------------------------------------------

| | |
|---|---|
| % One iteration over the code of 704 which corresponds | (13) |
| % to codeword w_2 and parity check matrix H2 | |
| %--------------------------------------------------------------------- | |
| %------Calculation of Messages from vector checknode 710 | |
| to vector variable node 712 ------ | |
| // gammaoutSij is the probability that wᵢ is equal to j | |
| gammaoutS20 = gammainS10*prob_x_00*priorS20 + | |

| | |
|---|---|
| | gammainS11*prob_x_10*priorS20; |
| gammaoutS21 = | gammainS10*prob_x_01*priorS21 + |
| | gammainS11*prob_x_11*priorS21; |

// mv_y is simply the LLR which is calculated from the above equations.
// mv_y is the message which is sent from vector check node 710 to
// vector variable node 712
mv_y = log(gammaoutS20/gammaoutS21);
%---------------------------------------------------------------------

| | |
|---|---|
| % | Send message to vector check node 714 |

%---------------------------------------------------------------------
% sparse matrix can be used to store messages
% add all incoming messages to a variable node together
sum_mv=full(sum(sparse(idx_c,idx_v,mv,num_c,num_v),1))+mv_y;
% sum all rows of a col
mc=sum_mv(idx_v)−mv;
%---------------------------------------------------------------------

| | |
|---|---|
| % | Send message back from vector check node 714 |
| % | to vector check node 712 |

%---------------------------------------------------------------------
log_mc=log_table(mc);
sum_log_mc=full(sum(sparse(idx_c,idx_v,log_mc,num_c,num_v),2));
log_mv=sum_log_mc(idx_c)−log_mc;
mv=inv_log_table(log_mv);
%---------------------------------------------------------------------

| | |
|---|---|
| % One iteration over the code of 702 which corresponds | (14) |

% to codeword w_1 and parity check matrix H1
%---------------------------------------------------------------------
%------Calculation of Messages from vector checknode 710
to vector variable node 720 ------

| | |
|---|---|
| gammainS21 = log(1/(1+exp(mv))); | // Converting the messages to bit |
| gammainS20 = log(1 − 1/(1+exp(mv))); | // probabilities |

// in this step gammainSij comes from the messages which are passed from
// vector variable node 712

| | |
|---|---|
| gammaoutS10 = | gammainS20*prob_x_00*priorS10 + |
| | gammainS21*prob_x_01*priorS10; |
| gammaoutS11 = | gammainS20*prob_x_10*priorS11 + |
| | gammainS21*prob_x_11*priorS11; |

```
  mv_y_2 = log(gammaoutS10/gammaoutS11);
  // We also have side information from the received vector r1 therefore
  // we find the message which comes from the node r1
  // assume that r1 is equal to y1
  //
for k = 1 : 1 : num_v
```

mv_y1(k) = log(prob( w1(k) = 0 | r1(k) = y1(k)) / prob( w1(k) = 1 |
r1(k) = y1(k)));

end
%---------------------------------------------------------------------

| | |
|---|---|
| % | Send message to vector check node 722 |

%---------------------------------------------------------------------
% sparse matrix to store messages to v nodes
% add all incoming messages to a variable node together
sum_mv_2= full(sum(sparse(idx_c2,idx_v2,mv_2,num_c2,num_v2),1))

+ mv_y_2 + mv_y1;

% sum all rows of a col
mc_2=sum_mv_2(idx_v2)−mv_2;
%---------------------------------------------------------------------

| | |
|---|---|
| % | Send message back from vector check node 722 |
| % | to vector check node 720 |

%---------------------------------------------------------------------
log_mc_2=log_table(mc_2);
sum_log_mc_2=full(sum(sparse(idx_c,idx_v,log_mc_2,num_c,num_v),2));
log_mv_2=sum_log_mc_2(idx_c)−log_mc;
mv_2=inv_log_table(log_mv_2);
%---------------------------------------------------------------------

| | |
|---|---|
| % Finding the message from vector variable node 720 | (15) |

% back to vector check node 710
%---------------------------------------------------------------------

| | |
|---|---|
| gammainS21 = log(1/(1+exp(mv_2))); | // Converting the messages to bit |
| gammainS20 = log(1 − 1/(1+exp(mv_2))); | // probabilities |

%---------------------------------------------------------------------
% RETURN TO iteration for w_2 in code segment (13)
%---------------------------------------------------------------------

Code segments (13) and (14) are then repeated until a predetermined threshold is reached, which constitutes a solution of partial factor graph 602 (or equivalently partial factor graph 606 depending on whether a forward or reverse decoding scheme is used). Generally, once the predetermined threshold has been reached, codeword, w₁, has been decoded correctly with high probability and the estimate of codeword, w₂, is very good. During the subsequent solution of partial factor graph 604, as discussed above, codeword w₂ is decoded correctly with high probability with an estimate of codeword, w₃, being very good, and so on.

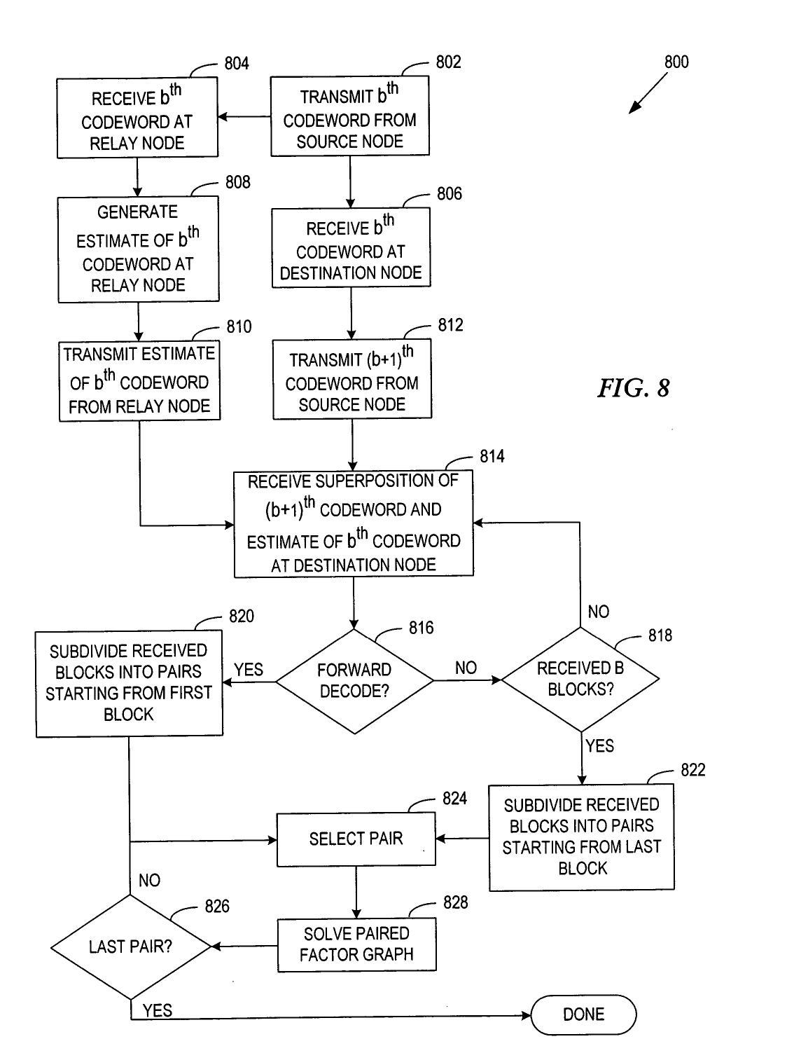

FIG. 8 exemplifies steps that may be executed during the simplified factor graph decoding algorithm in accordance with the present invention. As discussed above, transmission from the source node occurs in B equal length blocks b=1, 2, . . . , B as in step 802. Each b^{th} block is received at the destination and relay nodes as in steps 806 and 808, respectively, where in step 808, the relay node executes the de-noising process on the b^{th} received codeword, which results in the estimate of the b^{th} codeword (i.e., w_{b}′). Depending upon the quality of the received codeword at the relay node, w_{b}′ may represent a perfectly decoded codeword, or may represent a best estimate of the transmitted codeword, w_{b}. In any case, codeword w_{b}′ is transmitted to the destination node in the b+1 block as in step 810.

Simultaneously with step 810, codeword w_{b+1} is transmitted from the source node to the destination and relay nodes as in step 812. The superposition of the estimated codeword, w_{b}′, and codeword w_{b+1} is received at the destination node as in step 814. Depending upon whether the forward or backward decoding scheme is implemented, as determined in step 816, either the entire B blocks of information is received at the destination node through successive operations of steps 818 and 814 before the backward decoding scheme executes, or the forward decoding scheme executes as soon as the first pairs of blocks (i.e., block b and b+1) is received at the destination node.

In the case of the backward decoding scheme, the received B blocks are segmented into pairs starting from the last block as in step 822, where the first pair selected corresponds to partial factor graph 606 of FIG. 6 as in step 824. The paired factor graphs are then solved iteratively using the sum-product algorithm as discussed above as in step 828. Alternatively, the forward decoding scheme is used, whereby the received B blocks are segmented into pairs starting from the first block as in step 820. Forward decoding is then commenced by selecting the first pair as in step 824, which corresponds to partial factor graph 602 of FIG. 6. Both decoding methods are repeated until the entire B blocks of information have been decoded at the destination node.

It can be seen, therefore, that the backward decoding scheme imposes a decoding delay of at least B blocks, whereas the forward decoding scheme imposes a decoding delay of only two blocks. As discussed above, the backward decoding scheme exploits the idea of the analytical decode-and-forward coding protocol and hence has good performance when the relay node is located relatively close to the source node, e.g., about half way or less between the source and destination nodes. The forward decoding scheme, on the other hand, exploits the idea of the analytical estimate-and-forward protocol and hence has good performance when the relay node is located relatively far from the source node, e.g., about half way or more between the source and destination nodes.

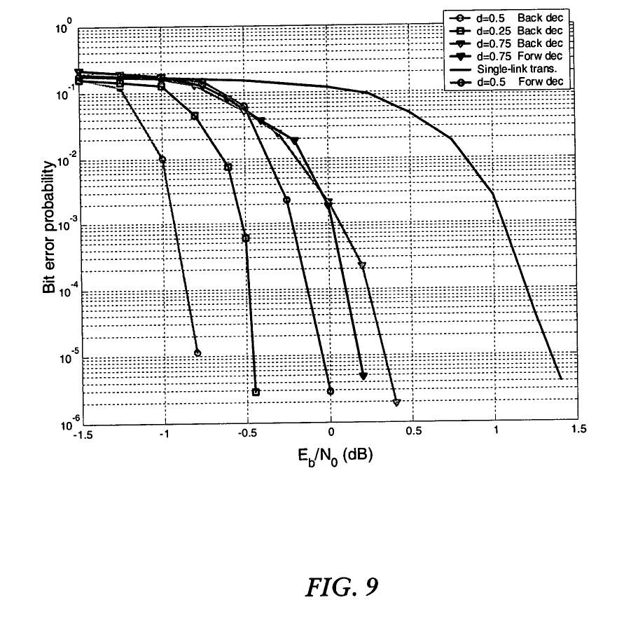

FIG. 9 illustrates exemplary performance of the proposed relay codes with LDPC constituent code of length 20,000 bits and rate R=½ for different position of the relay node at ¼, ½, and ¾ of the distance between source and the destination. The performance of both suboptimal decoding algorithms, forward decoding and backward decoding is shown. It can be seen that the designed code for the relay channel in accordance with the present invention can easily achieve 1-2 dB gain over the performance of the single user codes that do not use relaying for various positions of the relay node.

The foregoing description of the exemplary embodiment of the invention has been presented for the purposes of illustration and description. It is not intended to be exhaustive or to limit the invention to the precise form disclosed. Many modifications and variations are possible in light of the above teaching. For example, while the constituent codes have been illustrated as LDPC codes, other code types may be used, such as convolutional or turbo codes with equivalent results. It is intended that the scope of the invention be limited not with this detailed description, but rather determined by the claims appended hereto.

1. A relay channel, comprising:
a source node adapted to transmit a plurality of codewords;
a relay node coupled to receive the plurality of codewords and adapted to transmit an estimate for each codeword received; and
a destination node coupled to simultaneously receive a superposition of the plurality of codewords and estimates of the plurality of codewords and adapted to decode each transmitted codeword using partial factor graph decoding, wherein the codeword estimate improves the accuracy of the decoded codeword.

2. The relay channel of claim 1, wherein the codewords transmitted by the source node are each selected from a different codebook.

3. The relay channel of claim 2, wherein the codebook includes a constituent codebook that is jointly designed.

4. The relay channel of claim 1, wherein the estimate transmitted by the relay node for each codeword is the codeword itself.

5. The relay channel of claim 1, wherein the estimate transmitted for each codeword is the codeword estimated by a predetermined number of estimation iterations.

6. The relay channel of claim 1, wherein power allocated to the source node transmitter and the relay node transmitter conforms to an optimal power allocation between the relay transmitter and the source transmitter.

7. The relay channel of claim 6, wherein the optimal power allocation conforms to a ratio of the relay node transmission power to the sum of the relay node transmission power and the source node transmission power.

8. A method of forward decoding information blocks of a relay channel, the method comprising:
receiving a first information block at a relay node and a destination node;
estimating the first information block at the relay node;
receiving a superposition of a second information block and the first information block estimate at the destination node; and
jointly decoding the first and second information blocks at the destination node, wherein the first information block estimate improves a decoding accuracy of the second information block.

9. The method of claim 8, wherein estimating the first information block at the relay node comprises:
computing the log likelihood ratio (LLR) of the first information block using a first vector check node;
converting the LLR of the first information block to bit probabilities using a first vector variable node;
checking the bit probabilities against a parity check matrix using a second vector check node; and
exchanging messages between the second vector check node and the first vector variable node until a predetermined termination threshold is reached.

10. The method of claim 9, wherein the predetermined termination threshold is reached in response to complete compliance with the parity check matrix.

11. The method of claim 9, wherein the predetermined termination threshold is reached in response to a predetermined number of iterations.

12. The method of claim 8, wherein jointly decoding the first and second information blocks at the destination node comprises:
computing the log likelihood ratio (LLR) of the first information block using a first vector check node;
converting the LLR of the first information block to bit probabilities using a first vector variable node; and
checking the bit probabilities against a parity check matrix using a second vector check node.

13. The method of claim 12, wherein jointly decoding the first and second information blocks at the destination node further comprises:
computing the log likelihood ratio (LLR) of the superposition of the second information block and the first information block estimate using a third vector check node;
converting the LLR of the superposition of the second information block and the first information block estimate to bit probabilities using a second vector variable node; and
checking the bit probabilities against a parity check matrix using a fourth vector check node.

14. The method of claim 13, wherein jointly decoding the first and second information blocks at the destination node further comprises iteratively passing messages between the first and second vector variable nodes via the third vector check node until terminated by a predetermined termination rule.

15. A method of reverse decoding information blocks of a relay channel, the method comprising:
receiving a predetermined number of information blocks at a relay node and a destination node;
estimating the last information block received at the relay node;
receiving a superposition of a next to last information block and the last information block estimate at the destination node; and
jointly decoding the last and the next to last information blocks at the destination node, wherein the last information block estimate improves a decoding accuracy of the next to last information block.

16. The method of claim 15, wherein estimating the last information block at the relay node comprises:
computing the log likelihood ratio (LLR) of the last information block using a first vector check node;
converting the LLR of the last information block to bit probabilities using a first vector variable node;
checking the bit probabilities against a parity check matrix using a second vector check node; and
exchanging messages between the second vector check node and the first vector variable node until a predetermined termination threshold is reached.

17. The method of claim 16, wherein the predetermined termination threshold is reached in response to complete compliance with the parity check matrix.

18. The method of claim 16, wherein the predetermined termination threshold is reached in response to a predetermined number of iterations.

19. The method of claim 15, wherein jointly decoding the last and the next to last information blocks at the destination node comprises:
computing the log likelihood ratio (LLR) of the last information block using a first vector check node;
converting the LLR of the last information block to bit probabilities using a first vector variable node; and
checking the bit probabilities against a parity check matrix using a second vector check node.

20. The method of claim 19, wherein jointly decoding the last and the next to last information blocks at the destination node further comprises:
computing the log likelihood ratio (LLR) of the superposition of the next to last information block and the last information block estimate using a third vector check node;
converting the LLR of the superposition of the next to last information block and the last information block estimate to bit probabilities using a second vector variable node; and
checking the bit probabilities against a parity check matrix using a fourth vector check node.

21. The method of claim 20, wherein jointly decoding the last and the next to last information blocks at the destination node further comprises iteratively passing messages between the first and second vector variable nodes via the third vector check node until terminated by a predetermined termination rule.
